(19) United States
(12) Patent Application Publication
(10) Pub. No.: US 2004/0088869 A1
(43) Pub. Date: May 13, 2004

(54) Glass removing tool

(76) Inventor: Trevor Stanley Lock, Bendigo (AU)

Correspondence Address: Mark S Bicks, Roylance Abrams Berdo & Goodman, Suite 600, 1300 19th Street NW, Washington, DC, 20036, US

(21) Appl. No.: 10/343,910

(22) PCT Filed: Aug. 7, 2001
(86) PCT No.: PCT/AU01/00959

(30) Foreign Application Priority Data
Aug. 8, 2000 (AU) PQ 9253

(51) Int. Cl. B26B 15/00

(52) U.S. Cl. 30/355; 30/277.4

(57) ABSTRACT

The present specification discloses a cutting blade (10) for use with a tool (36) for reciprocating same intended for cutting sealing strips securing glass panels into a surrounding frame structure such as vehicle wind screens, the cutting blade (10) having a cutting region (11) with a cutting edge (37), the cutting region having one flat face (16) and an opposed face (14) that is curved in a convex shape with the thicker region of the blade being adjacent to and extending along a mid region thereof, the cutting edge (37) being formed along at least one side edge (26) of the cutting region (11) and around a free tip portion (22) of the cutting region (11), the cutting edge (37) being located, when viewed in the plane of the cutting region (11) of the blade (10), between the flat face (16) and the mid region of the second surface (14), the at least one side edge (26) having serrations (26) along at least a portion of the cutting edge (37).

The present invention relates to an improved blade for removing glass or other panels, particularly but not exclusively from motor vehicles. Such panels may include vehicle windscreens and other glass (or equivalent) panels in a vehicle but the blade is not limited to these applications.

Windscreens and other glass (or equivalent) panels in most modern motor vehicles are fitted with an encapsulated mould, many being an expensive permanent attachment, which surrounds the edge of the panel. An alternate material used for some vehicle windows but not usually the front windscreen is a polycarbonate material which is much softer than glass and therefore more easily damaged by tooling used to assist the removal of such panels. Moreover, the encapsulated mould may be made of rubber and/or other materials and the mould and edge of the windscreen are usually fixed to the motor vehicle by a strong adhesive elastomeric sealing strip such as polyurethane.

In many circumstances, it is necessary to remove the glass panel in one piece, without damaging the glass and the surrounding expensive encapsulated mould as a single unit, or body parts of the motor vehicle. Many vehicle body parts are these days made of aluminium, fibreglass and plastics materials and such materials may also be more easily damaged than steel or similar surrounds. Removal in one piece allows the glass panel to be removed and re-used. Such removal should be conducted in a manner preventing damage to the motor vehicle body which can cause rusting, or require expensive repair. Even if the glass or other panel is broken or damaged, it is desired to be able to remove same relatively easily without damage to the surrounding parts of the vehicle or the paint work.

Further to the foregoing, many non-glass panels in current vehicle constructions are now bonded together instead of using spot welds or have parts bonded thereto and it is equally important to have a blade to enable such panels to be removed without damage to the panel or surrounding parts of the vehicle or to have the bonded parts removed without arranging the panels. Some examples of these include rear hatch doors that have a PVC liner and a fibreglass outer which are bonded together and must be separated if only for recycling laws before disposal; trucks and buses that have fibreglass rooves or nose panels bonded to the remainder of the structure; accessories such as strips, mouldings or cover panels that are attached by adhesives including double sided adhesive tapes; and interior trims such as a headliner or a dash pad which may be located close to a glass or other panel. It is also important that electronic films or fine wire that may be located near the edge region of a glass (or equivalent) panel not be damaged by action of tooling that might be used to remove same from a vehicle installation.

There is an existing blade that has been able to remove vehicle glass panels, such as windscreens, in one piece, and it is described in Australian Patent No. 543405, in the name of Trevor Stanley Lock. This blade has a flat bottom face, a curved upper face, a curved tip portion, and sharpened edges lying in the plane of the flat bottom face and extending along a portion of the side edges and around the curved tip region. To remove the window, the sharpened portion of the blade was inserted into the adhesive elastomeric strip, and slid along the strip to break or cut the seal between it and the glass panel. A reciprocating power tool was used to move the blade in a reciprocating fashion to assist in the cutting of the elastomeric strip. Over recent years a variety of blade configurations have been developed for use in removing vehicle glass or other panels or for carrying out particular tasks to achieve this end result. Thus a skilled worker in this industry now needs to carry a complex variety of blades to complete satisfactorily the removal of glass or other vehicle panels whether broken or not.

Still further, when it is desired to remove a panel with a permanent rubber encapsulated mould of the type described above, existing blades have been found to have a problem in that, when the blade is slid along the sealing strip, its cutting direction is difficult to control, in that often such blades would exhibit a “rudder effect”. This rudder effect involved the blade moving in a direction that was not parallel to the sealing strip, with the effect that the blade either cut towards the glass, towards the permanent molding, or towards parts of the vehicle body often resulting in unwanted damage to the glass, permanent moulding or the vehicle parts.

Many modern windscreens also have a coating on the inside which is easily damaged, and therefore it is difficult to align a removal blade with reference to the window using guides or other apparatus that touch the windscreen for use as a reference point. Moreover, should a reciprocating blade engage this coating when attempting to remove a windscreen, significant damage might occur to the coating on the glass. Still further, it is also possible to scratch the glass itself without actually breaking the glass which is equally unacceptable.

It is an object of the present invention to provide a blade capable of overcoming problems associated with the prior art. In particular, it is an object of the present invention to provide a panel removal blade that exhibits a reduced rudder effect. More particularly, it is desired for the blade to have some rudder effect when initially entering a sealing strip to be cut, such that the blade does to some extent steer away from the glass surface, but thereafter such steering effects should be minimised to allow the blade to cut the sealing strip generally parallel to the glass. It is a further preferred objective to provide a panel removal blade that will minimise the number of different blades a skilled worker in this industry might need thereby minimising the training a skilled worker may need in selecting the right blade from the current variety of blades for various tasks including the multitude of vehicle glass panel installations.

In accordance with one aspect of the present invention, there is provided a blade for use in a tool capable of reciprocating said blade, having a cutting region including a cutting edge, the cutting region having a first substantially flat face and a second opposed surface that is curved in a convex manner when viewed in a transverse cross-section, said cutting edge being formed along at least one side edge of the cutting region and around a free tip portion of the cutting region, the cutting edge being located, when viewed in the plane of the cutting region of said blade, between said flat face and a mid region of said second surface, said at least one side edge having serrations along at least a portion of the cutting edge formed along its length.

It has been found that providing a cutting edge on a blade as described in the preceding paragraph, with the blade being reciprocated with the flat face directed towards the glass, the sharpened free tip portion does tend to steer away from the glass when initially inserted into the sealing strip to be cut. Moreover, having the flat face of the blade against the glass (or equivalent) panel provides much greater stability than existed with previously used reverse blades. Still further, with the cutting edge between the two surfaces of the blade, rudder effect or undesirable steering effects are minimised when the blade is cutting sideways after the initial penetration which also allows for the operator to steer the blade over the top of any encapsulated moulding edge. This is very difficult or almost impossible to achieve with existing blades cutting in a sideways direction.

Preferred aspects and features of the present invention have the features as defined in claims 2 to 12 annexed hereto which are hereby made part of this disclosure.

Preferably, the edges of the blades have scallops. The scallops assist with the cutting of the elastomeric strip. The scallops also increase the gap between the cutting edge and the face, thus allowing the blade to work closer to or on the window, encapsulated mould, or the substrate surface since the cutting edge is spaced from the contacting surface of the blade. The substrate surface may, for example, be a painted panel having imperfections such as spot welds or panel lapps and the blade according to the present invention may simply flow over the top of such imperfections.

In one form, the blade has a base portion, wherein the base portion is not co-linear with the blade. This enables an offset to be included into the tool such that the tool does not contact the window.

Preferably, the blade is flexible to enable better access to tight areas when being used and also to cater for curved and other variations in surface configurations.

A preferred embodiment will now be described with reference to the drawings, in which:

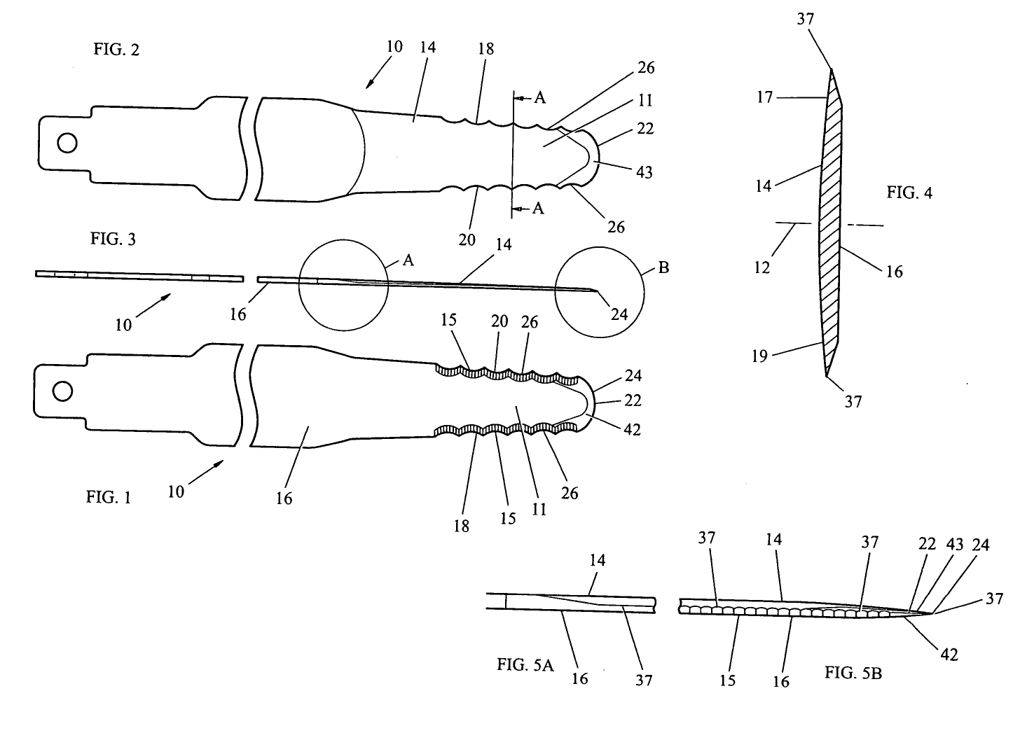

FIG. 1 is a bottom plan view of a first embodiment of the blade of the present invention;

FIG. 2 is a top plan view of the blade shown in FIG. 1;

FIG. 3 is a side edge view of the blade shown in FIG. 2;

FIG. 4 is a cross sectional view of the blade along the line A-A of the blade shown in FIG. 2;

FIG. 5A is an enlarged side edge view of the area A shown in FIG. 3;

FIG. 5B is an enlarged side edge view of the end of the blade shown in area B of FIG. 3;

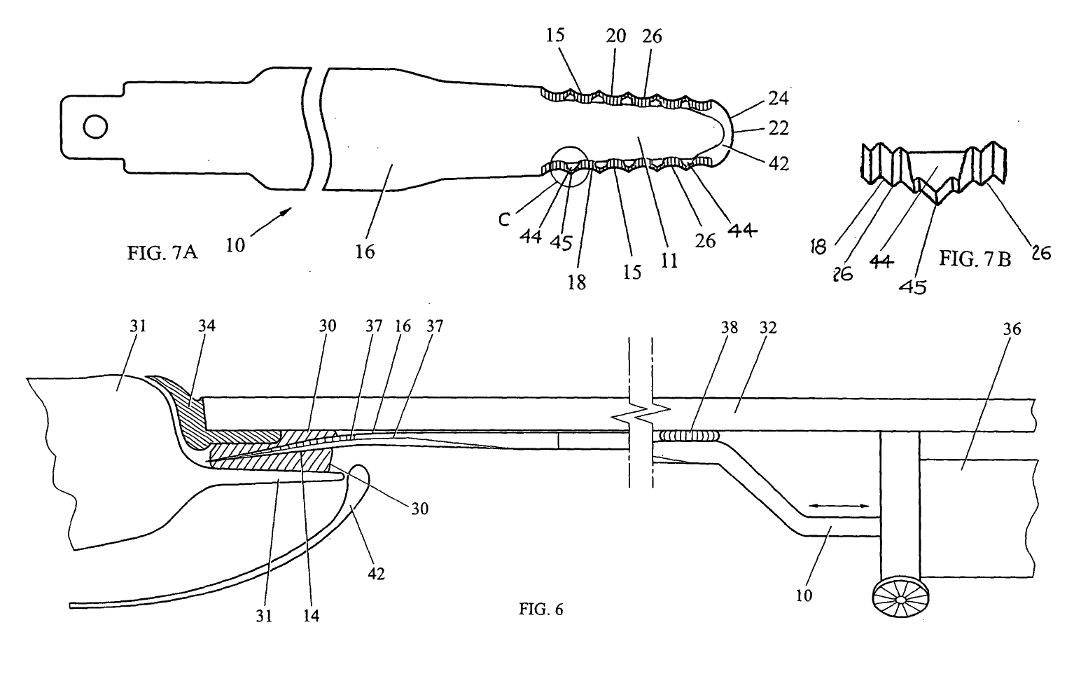

FIG. 6 is a view of a second embodiment of the blade of the present invention in use;

FIG. 7A is a bottom plan view similar to FIG. 1 of a second preferred embodiment of the blade of the present invention; and

FIG. 7B is an enlarged side edge view of the area C shown in FIG. 7A.

The blade 10 of FIG. 1 is conveniently made of flexible steel having an upper face 14 and a lower face 16. The upper face 14, at least in a cutting region 11, is curved in a convex shape as shown in FIGS. 2 and 4 whereby a mid region 12 of the blade is thicker than its side regions 17, 19. The lower face 16 is substantially flat, and has a cutting edge 37 extending along both side edges of the cutting region 12 and around a free tip portion 22. The cutting edge 37 is conveniently formed by sharpening from the flat face 16 or from both faces 16 and 14. Advantageously serrations 15 may be cut into the face 16, preferably at an angle to the plane formed by the substantially flat face (best seen in FIGS. 4 and 5).

The blade 10 has an end portion 22, which also has a sharpened edge 24 forming part of the cutting edge 37. The sharpened edge 24 is conveniently formed by grinding an oblique or angled face 42 from the flat face 16 of the blade. The sharpened edge 24 of the end portion 22 when viewed in plan view (FIG. 1) is continuously curved in a convex manner. Preferably, the sharpened edge 24 is also formed by grinding an oblique or angled face 43 from the curved face 14 of the blade. In an alternative arrangement, the end portion 22 might be formed with a square or chisel end configuration with the sharpened edge 24 being formed across the end and along adjacent side edges of the blade. In a still further potential arrangement, the end portion 22 may be square at the end but with rounded corners adjacent side edges of the blade, the cutting edge 24 extending across the square end and around the rounded corners. The edges 18 and 20 of the blade 12 may also include scallops 26, as shown in FIGS. 1 and 2, the scallops 26 conveniently having the serrations 15 cut into them at an angle to the second face 16. Thus, the blade 10 may have both scalloping 26 and serrations 15 to assist in the lateral cutting movement of the blade 10.

In the present embodiment, the serrations 15 and scallops 26 of the cutting edge 37 extend down the edges 18 and 20 of the blade rearwardly from the tip portion 22 approximately 35 mm, however different applications may require larger or smaller cutting edges. By the arrangement thus described, the cutting edge 37 is continuous along the two side edges of the blade at least in the cutting region 11 of the blade and around the tip portion 22, the cutting edge 37 always being located between the flat face 14 and the mid region 12 of the blade when viewed in a side ways direction as seen in FIGS. 3 and 5.

In use, as shown in FIG. 6, the blade 10 is inserted into the elastomeric strip 30 between the body 31 of the motor vehicle and the permanent mould 34 of the windscreen 32. Because of the structure of the blade and the form of sharpening, the blade will tend to lift away from the surface of the glass as it penetrates into the strip 30. The sharpened edge 24 of end portion 22 cuts the elastomeric strip 30 and once the blade 12 has been inserted into the strip 30 to the correct depth, the blade 12 is moved laterally, substantially parallel to the windscreen 32 whereupon the side edge regions of the cutting edge 37 cut the strip 30. Again, because the sharpened edge 37 is located between the two faces of the blade, it will not self steer to the same extent as a normal or a reverse blade when cutting in a sideways direction. A reciprocating power tool, for example, a compressed air driven tool 36, can be used to power the blade 12 back and forth in short reciprocating movements parallel to the body of the blade 12, assisting in the lateral movement of the blade 12. The serrations 15 and scallops 26 of the cutting edge 14 of the blade 12 combine to reduce the amount of lateral force required to cut the elastomeric strip 30. Further, the rudder effect is reduced as the angle of the serrations 15 at least partially offsets the curvature of the upper face 14, reducing the prevailing force tending to twist or turn the blade 10 away from a desired course. As the serrations 15 and scallops 26 reduce the amount of force required to cut the elastomeric strip 30, the operator can reduce the force laterally and exercise increased control over the direction of the blade 12.

FIGS. 7A and 7B illustrate potentially a still further preferred embodiment similar to FIGS. 1 to 3 except that the grinding of the surface 42 forming the sharpened edge 37 extends along each side edge of the blade 10 to form ground surfaces 44 removing part of the serrations adjacent the inner higher regions thereof at the scalloped points 45 of the side edges 18, 20. By removing this higher material, parts of the serrations likely to grab and undesirably hold the elastomeric sealing strip 30 being cut to cause unwanted self steering of the blade are removed thereby improving the cutting performance and user control of the blade.

Either blade 12 may be used with either side facing the windscreen or other panel 32, as the cutting edges 37 is always spaced from the upper and lower faces 14 and 16 respectively, and therefore a gap between the cutting edge and the faces assists in reducing damage to the windscreen 32 or body of the car 31, as seen in FIG. 6. If desired the blade may include a soft slide pad 38 to further assist guiding of the blade 10 and reduce potential damage to the glass 32.

Further, as can be seen from FIG. 6, the tool 10 may have a dogleg bend to allow room for the tool 10 and cutter 36 next to the windscreen 32. Alternatively, the tool 10 may be straight as shown in FIGS. 1 to 5. With a reasonable proportion of the blade rearwardly of the sharpened end region being flat on both surfaces. This arrangement enables the blade to be used with either flat face generally in contact with the glass (or similar) panel. This allows the tool 10 and blade 12 to be used on the inside of the windscreen 32, without interfering with internal fittings such as the headlining 42.

While the preferred embodiment shows the blade 10 of the tool 10 having both serrations 15 and scallops 26, the present invention may be accomplished by the use of serrations 15 alone, as the serrations 15 provide assistance in the cutting of the elastomeric strip 30, and also in the reduction of the rudder effect. The combined effect of the scallops and serrations reduces the lateral cutting force required still further.

The claims defining the invention are as follows:

1. A blade for use in a tool capable of reciprocating said blade, said blade having a cutting region including a cutting edge, the cutting region having a first substantially flat face and a second opposed surface that is curved in a convex manner when viewed in a transverse cross-section, said cutting edge being formed along at least one side edge of the cutting region and around a free tip portion of the cutting region, the cutting edge being located, when viewed in the plane of the cutting region of said blade, between said flat face and a mid region of said second surface, said at least one side edge having serrations along at least a portion of the cutting edge formed along its length.

2. A blade as claimed in claim 1, wherein said cutting edge around said free tip portion being formed by sharpening an edge region of the blade only from said first flat side towards said second side.

3. A blade as claimed in claim 1, wherein said cutting edge around said free tip portion being formed by sharpening an edge region of the blade from both the first and second faces.

4. A blade as claimed in claim 2 or claim 3, wherein the serrations are formed from said first flat side to said cutting edge.

5. A blade as claimed in claim 4, wherein said serrations extend fully along said one side edge.

6. A blade as claimed in claim 5, wherein the cutting edge extends along both side edges in said cutting region.

7. A blade as claimed in claim 6, wherein the serrations extend along both said side edges in the cutting region.

8. A blade as claimed in any one of claims 1 to 7, wherein said cutting edge when viewed at right angles to the plane of said blade is continuously curved in a convex manner in said free tip portion.

9. A blade as claimed in any one of claims 1 to 7, wherein said cutting edge when viewed at right angles to the plane of said blade extends across a substantially square edge in said free tip portion.

10. A blade as claimed in any one of claims 1 to 9, wherein at least one side edge region of the cutting edge extending rearwardly from said free tip portion is scalloped.

11. A blade as claimed in claim 10, wherein both the side edge regions of the cutting edge extending rearwardly from the tip portion are scalloped.

12. A blade as claimed in any one of claims 1 to 11, wherein the blade is formed substantially in one plane.

13. A blade as claimed in any one of claims 1 to 11, wherein the blade is formed with at least one transverse bend along the length of the blade.

14. A blade as claimed in any one of claims 1 to 13, wherein the blade is flexible at least in the cutting region thereof.
